(19) United States
(12) Patent Application Publication
(10) Pub. No.: US 2016/0341668 A1
(43) Pub. Date: Nov. 24, 2016

(54) ANGLED CONFOCAL SPECTROSCOPY

(71) Applicants: Raj Gupta, San Francisco, CA (US); Steven Francis Nagle, Cambridge, MA (US); Gajendra P. Singh, Allston, MA (US); Owen R. Falk, San Francisco, CA (US)

(72) Inventors: Raj Gupta, San Francisco, CA (US); Steven Francis Nagle, Cambridge, MA (US); Gajendra P. Singh, Allston, MA (US); Owen R. Falk, San Francisco, CA (US)

(21) Appl. No.: 15/111,894

(22) PCT Filed: Jan. 15, 2015
(86) PCT No.: PCT/US2015/011660

§ 371 Date: Jul. 15, 2016

Related U.S. Application Data
(60) Provisional application No. 61/927,475, filed on Jan. 15, 2014.

(51) Int. Cl. G01N 21/65; G01J 3/02; G01J 3/44

(52) U.S. Cl. CPC G01N 21/65; G01J 3/44; G01J 3/0208; G01J 3/0202; G01J 3/0237

(57) ABSTRACT

Disclosed herein are systems and methods for performing angled confocal spectroscopy. Angled confocal spectroscopy permits sensitive, non-invasive investigation of numerous analytes in a wide variety of samples, including tissues and bodily fluids. The methods and systems disclosed herein can be used to measure spectroscopic signatures of analytes within well-defined and very small regions of samples, while at the same time achieving superior rejection of signal contributions from analytes within the sample that do not fall within a volume of interest. Accordingly, measurements can be performed at comparatively high signal-to-noise ratios, and can provide information such as concentrations and distributions of sample analytes at high spatial resolution. By using cylindrically-focused illumination light, samples can be excited by a “sheet” of light, allowing spatial signal averaging and enhancing the stability and reproducibility of the measurements.

### CROSS-REFERENCE TO RELATED APPLICATIONS

This application claims priority to U.S. Provisional Patent Application No. 61/927,475, filed on Jan. 15, 2014, the entire contents of which are incorporated by reference herein.

### TECHNICAL FIELD

This disclosure relates to spectroscopic systems and methods.

### BACKGROUND

Techniques such as Raman spectroscopy can be used to detect analytes within samples with high specificity, because measured spectral features correlate with specific molecular features of the analytes. Accordingly, the measured features can be used as “fingerprints” for analytes, and can be used to identify particular analytes even when they are present in a complex chemical environment.

In addition to providing information about an entire sample, spectroscopic techniques can also be used to provide information about specific regions within a sample by measuring signals that originate from the specific regions. Confocal imaging methods can be used to ensure that measured signals include contributions from relatively small volumetric regions within a sample, enhancing the specificity of the information obtained.

Many spectroscopic techniques such as Raman spectroscopy rely on relatively weak measured signals to determine information about a sample. Stray illumination light and scattered background light can be present along the detection pathway, complicating the measurement process and, in some cases, limiting the applicability of certain spectroscopic techniques to samples of particular dimensions and/or composition.

### SUMMARY

The systems and methods disclosed herein use angled confocal imaging techniques to investigate selected regions of a sample. By illuminating the sample at an angle relative to orthogonal incidence and/or by measuring light from the sample at an angle relative to orthogonal emission, contributions to the measured signals from regions other than the region of interest, from scattered light, and/or from illumination light, can be significantly reduced and even eliminated.

The improvement in the rejection of spurious measurement signals from regions of a sample that are not of interest can be dramatic, and provides a significant number of benefits. Measurement signals can be obtained at signal-to-noise ratios that might otherwise be unattainable, due to the reduction in spurious signal contributions. As a result, spectroscopic techniques such as Raman spectroscopy that might otherwise yield signals too weak to provide accurate measurement results for certain samples can be used to investigate the samples. Further, samples which might otherwise be very difficult to investigate—such as samples that are highly scattering or feature numerous inhomogeneous structural domains—can be successfully probed and their analytes quantified using the angled confocal spectroscopic techniques disclosed herein. As a result, the methods and systems disclosed herein permit a wide range of spectroscopic probing of samples that would otherwise be too difficult or too inaccurate using conventional spectroscopic techniques.

The angled confocal spectroscopic techniques—like conventional confocal techniques—permit the optical sectioning of samples into a series of “layers” and the selective probing of a single layer while excluding signal contributions from other layers within the sample. However, because rejection of spurious signal contributions is improved relative to conventional confocal techniques, measurement signals can be obtained without the use of spatial apertures for signal clean-up. This advantage is particularly significant when the physical processes that give rise to the measured signal have relatively low quantum yields, such as Raman scattering. The elimination of spatial filtering apertures ensures that the relatively weak measurement signal will not be aperture-attenuated, increasing the signal-to-noise ratio, repeatability, and accuracy of the measurement results.

Enhanced rejection of signal contributions from regions of the sample that are not of interest improves the stability of sample measurements. Spurious signals due to processes such as scattering in regions of the sample that are not of interest typically have higher variability than signals derived from analytes within a region of interest. By reducing contributions from spurious signals to the measurement results, the stability of the measurement results can therefore be improved.

The angled confocal spectroscopy methods and systems disclosed herein can also be implemented using a variety of different types of sample illumination. For example, the sample can be illuminated with light focused to a small, diffraction-limited spot in the sample using spherical focusing optics. The use of suitably configured spherical optics for collecting measurement light can ensure that a volume of interest in the sample—from which signals are measured—is diffraction-limited in all three dimensions. Further, more complex optical assemblies including, for example, custom aspherical lenses or mirrors designed for the illumination wavelength can also be used, and in some embodiments, can yield an illumination spot that is even more tightly focused than spherical optics (e.g., a spot which, in some circumstances, is closer to a diffraction-limited spot than would be a corresponding spot generated using only spherical focusing optics).

Other modes of illumination are also possible. For example, the sample can be illuminated with light focused using cylindrical focusing optics. This creates a “light sheet” that converges to a line focus in the sample. Illuminating the sample with cylindrically-focused light can have a number of important advantages. Because the light is focused to a line rather than a spot, the light intensity within the focal region is reduced, which helps to prevent refractive various types of chemical (e.g., protein denaturing, photochemical reactions) and/or physical (e.g., photorefractive) damage to the sample. This can be especially important for spectroscopic techniques such as Raman spectroscopy, where relatively intense illumination light is used to excite the sample.

Cylindrical focusing of the illumination light also permits spatial averaging of the measured signals from the sample. By averaging the measured signals, the effects of variations due to local scattering and inhomogeneities to the measured signal are reduced, increasing the stability and repeatability of the measurement results. Moreover, spatially integrating the measured signals typically make the signals more readily detectable (since they are more intense) and less prone to interference from spurious (e.g., background) signals.

Signal stability can be further increased by selecting the volume of interest as the region of the sample that yields the most stable measurement signal. The line focus created by the cylindrical focusing optical elements can be scanned through a layer of the sample to identify a volume of interest from which measurement signals will be collected, ensuring that measured signals are as stable as possible.

The systems and methods disclosed herein can be used with a wide variety of samples, including tissues in vivo, tissues ex vivo (e.g. skin excited transcutaneously), tissue specimens in vitro (e.g., on a microscope slide and body fluids such as blood and urine contained in a cuvette). Accordingly, many different types of samples can be examined and the analytes therein identified and quantified. The information obtained about various analytes in the sample can be used for a variety of testing and diagnostic purposes, including identification of various conditions in a patient, and monitoring, whether in vivo, ex vivo, or in vitro, concentrations of various analytes in health monitoring applications. A principal example of an analyte that can be measured and quantified is glucose for purposes of testing diabetic patients.

In a first aspect, the disclosure features sample measurement systems that include a light source and illumination optics arranged to direct illumination light onto a sample, where the illumination light propagates along an illumination optical path having an illumination central axis oriented at an angle α larger than 0° and smaller than 70°, relative to a normal to a surface of the sample located at a position where the illumination central axis intersects the sample surface; measurement optics arranged to direct Raman scattered measurement light from the sample onto a detector, where the measurement light is collected along a measurement optical path having a measurement central axis oriented at an angle β larger than 0° and smaller than 70°, relative to a normal to the sample surface located at a position where the measurement central axis intersects the sample surface; a detector arranged to receive the measurement light and to generate a measurement signal; and an electronic processor configured to receive the measurement signal, and to analyze the measurement signal to identify at least one analyte in the sample.

Embodiments of the systems can include any one or more of the following features. For example, the electronic processor can be configured to determine a concentration or amount of the at least one analyte in the sample. The measurement light can be detected by the detector without passing through a spatial filtering aperture.

The illumination optics can include at least one cylindrical focusing element configured to focus the illumination light to an elliptical focal region within the sample. The cylindrically focused illumination light can form a light sheet within the sample. The illumination optics can include at least one spherical focusing element configured to focus the illumination light to a spherical focal region within the sample.

The illumination optics and the measurement optics can define a spatial region corresponding to a volume of interest within the sample, and the volume of interest can be diffraction-limited in size in at least one dimension at the wavelength of the illumination light. The volume of interest can be diffraction-limited in size in three dimensions at the wavelength of the illumination light.

The systems can include a display unit, and the electronic processor can be configured to display information about the identity of the at least one analyte on the display unit.

The systems can include a sample manipulator coupled to the electronic processor, and the electronic processor can control the sample manipulator to deform the surface of the sample prior to illumination of the sample. The systems can include a sample manipulator configured to receive information from a user of the system and to deform the surface of the sample based on the information from the user. The electronic processor can control the sample manipulator to deform the surface of the sample so that an angle between the illumination central axis and the normal to the surface of the sample located at the position where the illumination central axis intersects the sample surface is smaller than an angle between the illumination central axis and the normal to the surface of the sample located at the same position when the surface of the sample is not deformed. The electronic processor can be configured to deform the surface of the sample so that an angle between the measurement central axis and the normal to the sample surface located at the position wherein the measurement central axis intersects the sample surface is smaller than an angle between the measurement central axis and the normal to the sample surface located at the same position when the surface of the sample is not deformed.

The systems can include a sample manipulator coupled to the electronic processor, where the illumination optics and the measurement optics define a spatial region corresponding to a volume of interest within the sample, and where the electronic processor is configured to control the sample manipulator to deform the sample using the sample manipulator to position a selected region of the sample within the volume of interest.

The at least one analyte can include any one or more of glucose, lactate, creatinine, hemoglobin, aldehydes, ketones, and cancerous tissue. The sample can include multiple layers, and the at least one analyte can be localized in one of the layers. The light source and illumination optics can be arranged to direct illumination light transcutaneously into an interior region of the sample.

Embodiments of the systems can also include any of the other features disclosed herein, including combinations of features that are separately disclosed in connection with different embodiments, in any combination as appropriate.

In another aspect, the disclosure features sample measurement methods that include directing illumination light onto a sample along an illumination optical path for which an illumination central axis is oriented at an angle α larger than 0° and less than 70° relative to a normal to a sample surface located at a position where the illumination central axis intersects the sample surface; measuring Raman scattered measurement light from the sample along a measurement optical path for which a measurement central axis is oriented at an angle β larger than 0° and less than 70° relative to a normal to the sample surface located at a position where the measurement central axis intersects the sample surface; generating a measurement signal corresponding to the measurement light; and analyzing the measurement signal to identify at least one analyte in the sample.

Embodiments of the methods can include any one or more of the following features. For example, the methods can include determining a concentration or amount of the at least one analyte in the sample. The methods can include focusing the illumination light to an elliptical focal region within the sample. The methods can include focusing the illumination light to form a light sheet within the sample.

The methods can include measuring the measurement light using a detector without directing the measurement light through a spatial filtering aperture. The methods can include displaying information about the identity of the at least one analyte on a display unit.

The methods can include deforming the sample to position a selected region of the sample within a volume of interest defined by illumination optics used to direct illumination light onto the sample and measurement optics used to measure Raman scattered measurement light from the sample.

The at least one analyte can include any one or more of glucose, lactate, creatinine, hemoglobin, aldehydes, ketones, and cancerous tissue. The sample can include multiple layers, and the at least one analyte can be localized in one of the layers. The methods can include directing illumination light transcutaneously into an interior region of the sample.

Embodiments of the methods can also include any of the other features disclosed herein, including combinations of features that are separately disclosed in connection with different embodiments, in any combination as appropriate.

Unless otherwise defined, all technical and scientific terms used herein have the same meaning as commonly understood by one of ordinary skill in the art to which this disclosure belongs. Although methods and materials similar or equivalent to those described herein can be used in the practice or testing of the subject matter herein, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments are set forth in the accompanying drawings and the description below. Other features and advantages will be apparent from the description, drawings, and claims.

### DESCRIPTION OF DRAWINGS

FIG. 1 is a schematic diagram of an embodiment of an angled confocal spectroscopy system.

FIG. 2 is a schematic diagram of another embodiment of an angled confocal spectroscopy system.

FIG. 3 is a schematic diagram of an embodiment of an angled confocal spectroscopy system that includes a sample manipulator.

FIG. 4 is a schematic diagram of an embodiment of an angled confocal spectroscopy system in which the sample is deformed to account for refractive index mismatch.

FIG. 5 is a flow chart showing a series of example steps for performing angled confocal spectroscopy measurements on a sample.

FIG. 6 is a schematic diagram showing an embodiment of a sample manipulator.

FIG. 7 is a schematic diagram showing an embodiment of a plate for sample deformation.

FIG. 8 is a schematic diagram showing orientations of the axes of the illumination and measurement optical paths.

Like reference symbols in the various drawings indicate like elements.

### DETAILED DESCRIPTION

Spectroscopic techniques such as Raman spectroscopy, harmonic generation, and fluorescence emission can provide valuable information about molecular constituents present in a sample. Many such techniques generate measurable signals that are specific to particular constituents or chemical features of constituents. Accordingly, measured signals can be used as “fingerprints” that identify constituents within a sample. For example, certain Raman emission bands can serve as reliable diagnostic indicators for the presence of particular chemical moieties (e.g., particular vibrational resonances) within molecules in a sample. Detected singly or in combination, the emission bands function as reliable diagnostic indicators for particular sample constituents. Furthermore, emission band intensities can be detected with sufficient accuracy so that amounts of the sample constituents can be accurately quantified.

However, a number of significant challenges exist when implementing spectroscopic techniques for the detection and quantification of constituents of complex samples such as biological tissues. Many spectroscopic techniques such as Raman spectroscopy generate relatively weak signals (e.g., weak compared to the intensity of the illumination light delivered to the sample to induce the sample's response). As a result, spurious contributions to the measured signals from excess illumination light and from scattering and other processes in the sample can obscure and even overwhelm the signals from constituents of interest in the sample. While optical techniques such as filtering (e.g., by using bandpass filters) can reduce such spurious contributions, these optical techniques also typically reduce the intensity of the already-weak signals of interest, further complicating the measurement of such signals.

Spurious contributions to the measured signals can also be contributed by portions of a sample that are outside a region of interest. Typically, filters such as bandpass filters are not effective at significantly reducing such contributions, as the optical wavelength of such contributions is similar to signal contributions that arise from the region of interest.

Confocal imaging methods can be used to effectively optically extract a small sample volume from within different layers, and through planar and depth scanning of each small sample volume, to reconstruct a 3D image of the sample under investigation. This method of probing enables measurement of signals from small localized volumes within the sample, and reduces contributions to the measured signals from adjacent volumes that can produce interference. However, when the illumination and imaging optical paths overlap in confocal imaging, measured signals can still include contributions from portions of the sample other than from the probed volume of interest, due to scattering and other optical phenomena within the samples. As a result, depth-dependent investigation of structured or granular samples can be challenging.

To circumvent the above challenges associated with confocal imaging, the present disclosure describes angled confocal imaging systems and methods that can be used to implement a variety of different sample measurement techniques, including methods such as Raman spectroscopy and fluorescence spectroscopy. By using angled illumination and signal measurement, signals originating from a volume of interest (VOI) within the sample can more readily be isolated from background signals that are not of interest.

### System Overview

In general, the systems and methods disclosed herein include an illumination optical path and a measurement (collection) optical path. The VOI is located in relative proximity to the intersection of these two paths. In some embodiments, for example, the VOI is located at the intersection of these optical paths. In certain embodiments, the VOI is displaced from the intersection of the optical paths. Typically, displacement can occur in any of the three coordinate directions, but displacements in the direction of the sample's thickness (e.g., in along the z-coordinate direction, as will be explained later) are most common. For example, in some embodiments, the intersection between the illumination and measurement optical paths occurs at a position in the sample that is deeper (e.g., with respect to a surface of the sample on which illumination light is incident) than the location of the VOI. Such a configuration can permit, in some embodiments, even larger reductions in contributions (e.g., background noise) from sample regions that are not in the VOL. As an example, where the intersection of the illumination and measurement optical paths is positioned in a sample layer that is highly Rayleigh scattering, the VOI can be positioned at a location displaced from the intersection, in a portion of the sample that does not exhibit such large scattering, to reduce the number of stray photons entering the VOL.

In general, because the illumination and measurement optical paths are not collinear, background contributions from portions of the sample along the illumination optical path are significantly reduced in the measurement optical path, relative to a collinear geometry. As a result, the systems and methods disclosed herein are capable of measuring relatively weak signals from a VOI that might otherwise be too difficult to accurately measure due to spurious background signals.

The systems and methods disclosed herein can employ a variety of different focusing schemes for delivering illumination light to a sample. In some embodiments, the illumination light can be focused to a spherical focal volume within the sample by one or more spherical or aspherical focusing optical elements. Focusing light to a spherical region within the sample can be advantageous because, in principle, the distribution of illumination light is nominally symmetric. Further, the illumination light can be concentrated into a relatively small focal region, increasing the intensity of the light in that region. This can be important for applications in which the sample response is generated by an optical process with a relatively low quantum yield, such as Raman scattering.

In some embodiments, the illumination light can be focused to a nominal “line focus” within the sample, which effectively yields an elliptical focal volume, by one or more cylindrical focusing optical elements. Cylindrical focusing of the illumination light generates a “light sheet” that penetrates the sample and converges within a region (which can be co-located with the VOI or outside the VOI) interior to the sample. Focusing the illumination light cylindrically can also have a number of advantages in certain applications. For example, focusing the illumination light cylindrically and then measuring light from the sample in response to the line focus excitation effectively spatially averages the measurement signal over a larger spatial region of the sample that with spherical focusing. As a result, measured signals are typically more stable and repeatable, as the effects of random local variations are averaged out. In effect, the use of cylindrical focusing of the illumination light—in concert with suitably chosen measurement optics (e.g., piano optical systems) can increase the signal-to-noise ratio in the measured signals, and the repeatability of the measurement results.

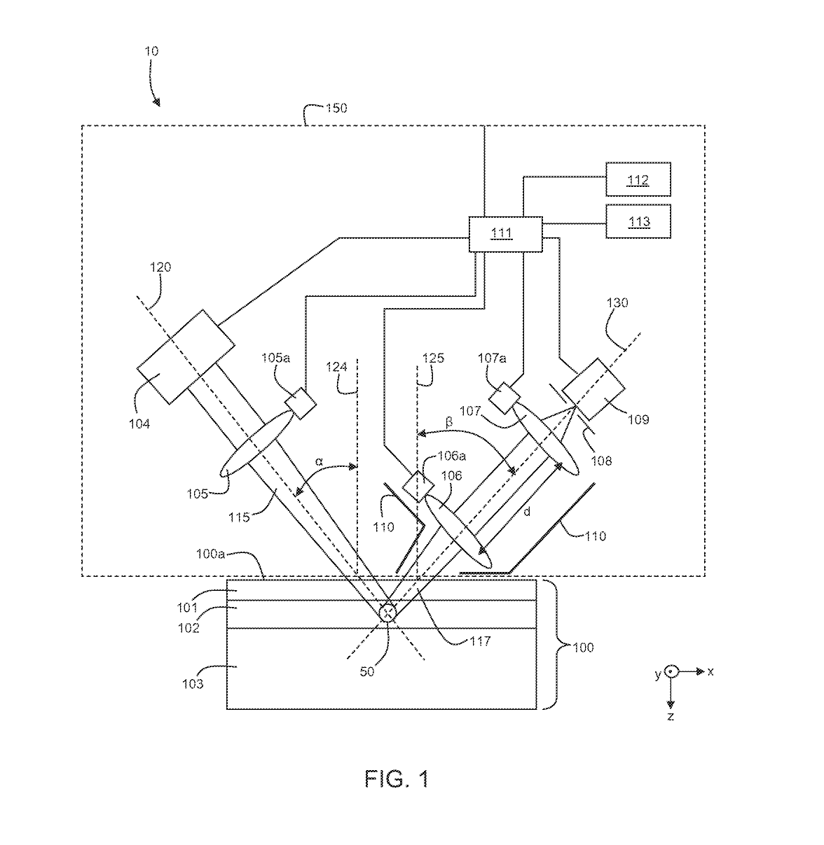

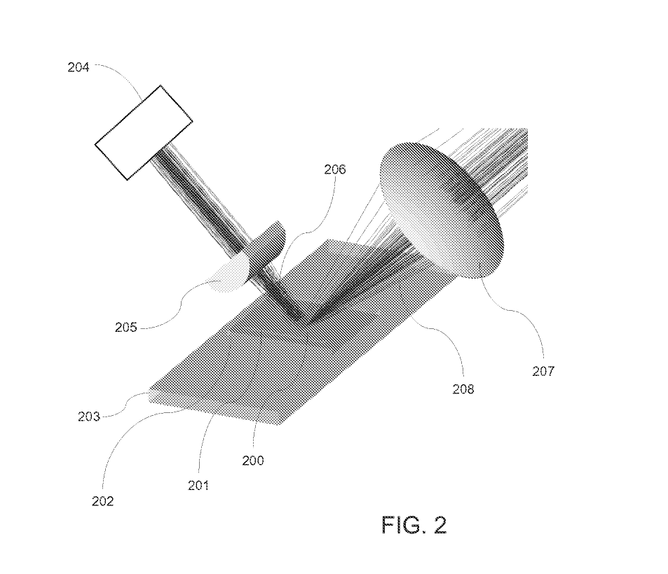

Further, cylindrical focusing of the illumination light can reduce the light intensity in the focal volume relative to spherical focusing. While more intense illumination light typically yields stronger sample responses for processes such as Raman scattering, high light intensities also have the potential to cause various types of damage (e.g., protein denaturing, chemical transformations and photochemistry, photorefractive damage, and/or heat-related damage) in sensitive samples such as biological tissues. Cylindrical focusing of the illumination light can mitigate the chances for such damage by reducing the local intensity of the illumination light. Alternatively, it may allow higher laser power than might be safely allowed if limited to smaller confocal spherical volumes. This may be useful for high-speed gated spectroscopy that helps to eliminate background ambient light. In the following discussion, systems and methods that implement spherical focusing of the illumination light are discussed with reference to FIG. 1, and cylindrical focusing is discussed in connection with FIG. 2.

In the following discussion, the illumination and measurement optical paths intersect within the VOI, and the illumination light is focused within the VOI, for purposes of discussion and to illustrate general features of the systems and methods disclosed herein. However, it should be understood that more generally, the illumination and measurement paths are not required to intersect near the VOI, and in some embodiments (including all of the embodiments discussed herein), the VOI can be displaced from the intersection of the illumination and measurement paths. Furthermore, it should be understood that in general, the illumination light can be focused to a region of the sample either within the VOI or outside the VOI. In certain embodiments (including all of the embodiments discussed herein), the position of best focus of the illumination light (i.e., the position where the beam waist is smallest) can be located outside the VOL.

With the foregoing in mind, FIG. 1 shows a schematic diagram of a system 10 for performing angled confocal spectroscopy. In FIG. 1, an illumination source 104 directs illumination light 115 to illumination optics 105, which focus illumination light 115 into a VOI 50 within sample 100. Illumination optics 105 define an illumination optical pathway, which is indicated by the central axis 120 of the pathway. Central axis 120 is also referred to as the illumination central axis of system 10.

Sample 100 includes multiple layers 101, 102, and 103 in FIG. 1. More generally, sample 100 can include a single layer, more than one layer, or multiple homogeneous and/or non-homogeneous domains within its volume. Illumination optics 105 can be configured to direct illumination light 115 to any VOI 50 within the volume of sample 100.

Measurement light 117 emerges from VOI 50 in sample 100, and is collected by measurement optics 106 and 107. Measurement optics 106 and 107 deliver the measurement light to a detector 109, which measures and analyzes the measurement light. Measurement optics 106 and 107 define a measurement optical pathway, which is indicated by the central axis 130 of the pathway in FIG. 1. Central axis 130 is also referred to as the measurement central axis of system 10.

In some embodiments, an electronic processor 111 is coupled to detector 109 (and optionally to illumination source 104). Electronic processor 111 can be configured to transmit operating instructions to control illumination source 104 and detector 109, and to receive measurement signals from detector 109. System 10 can also include a display 112 and a user interface 113, each coupled to processor 111, to allow processor 111 to receive input from, and display measurement results to, a system operator.

In general, illumination optics 105 can include any one or more optical elements —including lenses, mirrors, filters, diffractive elements, windows, and beam splitters—for directing illumination light 115 into VOI 50. Similarly, measurement optics 106 and 107—although depicted in FIG. 1 as a relay imaging apparatus, can more generally include any one or more optical elements, including lenses, mirrors, filters, diffractive elements, windows, and beam splitters, for directing measurement light 117 to detector 109. In some embodiments multiple optical functions can be combined into one element, such as a diffractive element backed by a focusing mirror, or an optical thin-film filter combined with a piano-convex lens.

Illumination source 104 can generally include any one or more of a variety of sources, including (but not limited to) laser sources (e.g., lasers, laser diodes), LED-based sources, and incandescent and/or fluorescent sources. Detector 109 can generally include one or more of a variety of detectors, including CCD arrays, CMOS-based detectors, diode-based detectors, bolometers, pyrometers, and spectrometers.

In FIG. 1, VOI 50 is positioned at the intersection of the illumination and measurement optical pathways defined by illumination optics 105 and measurement optics 106 and 107, respectively (although as explained above, in some embodiments, the illumination and measurement optical pathways intersect in a region of the sample outside the VOI). In some embodiments, illumination optics 105 are configured so that the minimum beam waist of illumination light 115 is located within VOI 50. Further, in certain embodiments, measurement optics 106 and 107 are configured so that the focal minimum (e.g., the nominal focal position of measurement optics 106 and 107) is positioned within VOI 50, at the location of the minimum beam waist of illumination light 115. In this configuration, measurement optics 106 and 107 collect light from substantially within VOI 50, and contributions to the measurement light from regions of sample 100 outside VOI 50 can be significantly reduced relative to configurations where the focal position of measurement optics 106 and 107 does not coincide with the minimum beam waist of illumination light 115.

In certain embodiments, by positioning illumination optics 105 and/or measurement optics 106 and 107 as discussed above, VOI 50 can be diffraction-limited in one-, two-, or three-dimensions. A VOI that is diffraction-limited in three-dimensions corresponds to the smallest volume within sample 100 from which measurement light can be collected, while significantly reducing contributions to the measurement light from regions outside VOI 50.

In some embodiments, by suitably positioning illumination optics 105 and/or measurement optics 106 and 107, VOI 50 has a shape that is approximately elliptical, with a length along the major axis of 5 mm or less (e.g., 4 mm or less, 3 mm or less, 2 mm or less, 1.5 mm or less, 1.0 mm or less) and a length along a minor axis of 4.5 microns or less (e.g., 4.0 microns or less, 3.0 microns or less, 2.0 microns or less, 1.0 micron or less, 0.5 microns or less, 0.4 microns or less).

Conversely, a VOI that is diffraction-limited in only two dimensions (or only one dimension, or no dimensions) does not correspond to the smallest VOI that can be realized within sample 100 by system 10. Nonetheless, for certain applications, it can be advantageous to define a larger VOI 50 within sample 100 (e.g., a VOI that is not fully diffraction-limited). For example, in certain applications, a certain amount of imaging spatial resolution can be sacrificed to yield stronger measurement signals (i.e., since the measurement signals include contributions from a larger VOI within sample 100).

In some embodiments, one or more of illumination optics 105 and measurement optics 106 and 107 can be controlled by processor 111. For example, as shown in FIG. 1, illumination optics 105 can be coupled to one or more actuators 105a, and measurement optics 106 and 107 can be coupled to one or more actuators 106a and 107a. Actuators 105a, 106a, and 107a are in turn coupled to processor 111, which can be configured to adjust the positions of the various elements of illumination optics 105 and measurement optics 106 and 107 relative to sample 100.

In this manner, electronic processor 111 can control the position and size of VOI 50 within sample 100.

In some embodiments, illumination source 104, illumination optics 105, measurement optics 106 and 107, and detector 109 can be mounted on a translation stage 150 which is coupled to processor 111. Translation stage 150 allows movement in each of the x-, y-, and z-coordinate directions shown in FIG. 1, and electronic processor 111—by transmitting appropriate control signals to translation stage 150—can adjust the position of the overall system relative to sample 100. Thus, processor 111 can position VOI 50 at any three-dimensional location within sample 100 by adjusting the position of translation stage 150. For example, processor 111 can position VOI 50 within any of layers 101, 102, or 103 by adjusting the z-coordinate position of translation stage 150. Further, within any of these sample layers, processor 111 can position VOI 50 laterally (i.e., within the x-y plane of FIG. 1) by adjusting the x- and y-coordinate positions of translation stage 150.

In some embodiments, processor 111 can be configured to determine a suitable VOI 50 within a layer of sample 100 by scanning translation stage 150 in the x-y plane over multiple candidate sites, and detecting measurement light corresponding to each candidate site. The candidate site for which the signal corresponding to the detected measurement light is strongest (e.g., most intense) can then be designated by processor 111 as the VOI for the particular analyte(s) in the sample that correlates with the measured signal.

As shown in FIG. 1, the illumination optical path is angled with respect to the surface of sample 100 upon which illumination light 115 is incident. In particular, the central axis 120 of the illumination optical path is oriented at an angle α with respect to a surface normal 124 at the point where central axis 120 intersects surface 100a.

Similarly, the measurement optical path is angled with respect to surface 100a from which measurement light 117 emerges. The central axis 130 of the measurement optical path is oriented at an angle β with respect to a surface normal 125 at the point where central axis 130 intersects surface 100a.

In general, angles α and β can be chosen independently according to the nature and structure of the sample, and the measurement technique being performed. Angles α and β can be independently selected, for example, by processor 111, which delivers suitable control signals to actuators 105a, 106a, and/or 107a, to control the positions of illumination optics 105 and measurement optics 106a and 107a, thereby adjusting the orientations of central axes 120 and/or 130. Processor 111 can receive input from a system operator that includes instructions regarding suitable values of angles α and/or β, and can then generate the control signals. Alternatively, in some embodiments, processor 111 can determine suitable values of angles α and/or β using stored configuration settings, based on information about the sample and/or information about the measurement technique.

Various factors and/or criteria can be used to select suitable values of α and β. For example, in some embodiments, where the illumination light is polarized, α can be chosen to minimize reflection of the polarized illumination light at the sample surface (e.g., a can correspond to Brewster's angle for TM-polarized illumination light). As another example, for some samples, α and β can be selected together to reduce or minimize an effective optical path length within the sample. By reducing or minimizing the optical path length, signal losses (e.g., due to absorption of the measurement light and/or Rayleigh scattering of the measurement light) can be reduced, while the total length of the optical path can be still be long enough so that the measurement light yield measurement signals of sufficient signal-to-noise ratio. As a further example, β can be selected to ensure that a significant fraction of the measurement light exits through the surface of the sample, and is not reflected downward from the sample surface into the bulk region of the sample.

In general, while angles α and β can be the same for some samples and/or measurement techniques, more generally, angles α and β can have different values. In some embodiments, α can be between 0° and 70° (e.g., larger than 0° and smaller than 70°, between 5° and 70°, between 5° and 60°, between 10° and 60°, between 15° and 60°, between 10° and 50°, between 15° and 50°, between 20° and 40°). In certain embodiments, α can be larger than 5° (e.g., larger than 10°, larger than 20°, larger than 30°, larger than 40°, larger than 50°, larger than 60°).

Similarly, β can be between 0° and 70° (e.g., larger than 0° and smaller than 70°, between 5° and 70°, between 5° and 60°, between 10° and 60°, between 15° and 60°, between 10° and 50°, between 15° and 50°, between 20° and 40°). In certain embodiments, β can be larger than 5° (e.g., larger than 10°, larger than 20°, larger than 30°, larger than 40°, larger than 50°, larger than 60°).

In some embodiments, angles α and β are selected together according to a mutual condition. For example, α and β can be selected such that the sum of the angles, α+β, is 10° or more (e.g., 20° or more, 30° or more, 40° or more, 50° or more, 60° or more, 70° or more, 80° or more, 90° or more, 110° or more, 120° or more, 130° or more). In certain embodiments, it can be advantageous if the sum of angles α and β is approximately 90°, that is, α+β is between 80° and 100° (e.g., between 85° and 95°, between 87° and 93°).

In FIG. 1, measurement light 117 is focused through an aperture 108 before the light is incident on detector 109. As is known from the field of confocal imaging, aperture 108 acts as a spatial filter to remove contributions from measurement light 117 that do not arise from VOI 50. However, when measurement light 117 has a relatively low intensity (e.g., when measurement light 117 is generated by an optical process with a relatively low quantum yield, such as Raman scattering), aperture 108 can sometimes also filter out photons that are generated within VOI 50.

To avoid filtering light generated from within VOI 50, in some embodiments, angles α and β are selected to ensure that contributions to measurement light 117 from sample regions other than VOI 50 are so small that aperture 108 can be removed from system 10. In other words, system 10 permits aperture-less confocal imaging and spectroscopy of sample 100 by using a suitable combination of angles α and β. For example, in some embodiments, aperture-less detection of measurement light 117 from sample 100 can be performed with an angles α and β selected as described above. Further, it has been discovered that in certain embodiments, α is preferentially selected to be larger than β.

In some embodiments, as discussed above, illumination light 115 is focused to a region of the sample that is outside the VOI. When the systems are configured in this manner, further exclusion of spurious signals due to portions of the sample outside the VOI can be achieved. Moreover, illuminating the sample at one location and detecting measurement light that corresponds to a VOI that lies outside the focal region of illumination light 115 can be used to probe deeper layers within the sample. In general, photons corresponding to measurement light propagate both vertically (e.g., in a direction normal to the sample surface) and laterally (e.g., in a direction parallel to the sample surface). Further, photons that are generated from deeper lying layers in the tissue propagate further in lateral directions before they reach the sample surface. Accordingly, by detecting measurement light from a region that is offset laterally (i.e., in the x-y plane) from the focal region of illumination light 115, VOIs at different depths below the sample surface can be probed.

To further reduce contributions to measurement light 117 from sample regions outside VOI 50, the spacing d between measurement optics 106 and 107, measured along central axis 130, can be adjusted (e.g., by processor 111). For example, in some embodiments, d is 0 cm or more (e.g., 0.1 cm or more, 0.2 cm or more, 0.5 cm or more, 1 cm or more, 2 cm or more, 5 cm or more, 10 cm or more, 20 cm or more, 30 cm or more, 50 cm or more, 75 cm or more, 1.0 m or more, 5.0 m or more, 10.0 or more, 20.0 m or more, 50.0 m or more). For aperture-less detection of measurement light 117, d can be 1.0 m or more (e.g., 2.0 m or more, 5.0 m or more, 10.0 m or more, 20.0 m or more, 30.0 m or more, 40.0 m or more, 50.0 m or more).

In some embodiments, as shown in FIG. 1, one or more light shields 110 can be used. Light shields, which are typically formed of an opaque material such as a metal or plastic often coated with high absorbers, assist in preventing stray light—which can include contributions from regions of sample 100 other than VOI 50, and from illumination light 115—from reaching detector 109. Absorption of stray light by light shields 110 also helps to reduce re-scattering events in the sample.

In general, the plane in which axis 120 and normal 124 lie is not necessarily coplanar with the plane in which axis 130 and normal 125 and lie. Thus, α and β are not necessarily measured in the same plane. However, in some embodiments, α and β are measured in a common plane, such as the x-z plane of FIG. 1. In such implementations, α can represent the angle between normal 124 and the projection of axis 120 on the x-z plane. Similarly, β can represent the angle between normal 125 and the projection of axis 130 on the x-z plane. Further, in such implementations, axis 120 can be oriented at an angle γ to normal 124 in the y-z plane, and axis 130 can be oriented at angle δ to normal 125 in the y-z plane. FIG. 8 is a schematic diagram showing the angular relationships in the y-z plane. In FIG. 8, the projection of axis 120 on the y-z plane forms an angle γ with normal 124, while the projection of axis 130 on the y-z plane forms an angle δ with normal 125.

In general, the angles γ and δ can take any of the values disclosed above in connection with α and β. Moreover, γ and δ can be chosen such that they satisfy any of the criteria or relationships disclosed above for α and β.

A significant advantage of the angled confocal spectroscopy systems and methods disclosed herein is that they permit highly selective control over the depth (i.e., in the z-direction) at which samples can be probed, and reduce or exclude signal contributions arising from sample regions outside all but a narrow range of depths centered around the nominal probing depth. This feature is particularly important for a number of samples, including biological tissue samples, where one or more highly scattering layers (e.g., skin and fat) overlie a deeper tissue layer of interest. For example, the tissue probing depth in many biological samples is about 1 mm±30%, which is deep enough to investigate analytes in blood vessels that are present in relatively deep tissues. The angled confocal spectroscopy systems and methods disclosed herein permit probing at such depths and exclusion of scattered light from tissue layers at depths of less than 1 mm (and depths of more than 1 mm). Experiments have shown that a probing depth of about 1 mm is generally sufficient to interrogate analytes in regions of a sample below the dermal layers (e.g., the dermis and epidermis), which improves the repeatability and accuracy of analyte measurements.

For the systems disclosed herein, the effective probing depth range can be defined as the range of depths around a nominal depth for which measurement signals emerging from the sample are not shot-noise limited. In other words, the signals emerging from the sample include at least one signal photon (e.g., have a signal-to-noise ratio of at least 1:1 following subtraction of background signals). For the systems and methods disclosed herein, the probing depth range can be 1 micron or less (e.g., 500 nm or less, 300 nm or less, 200 nm or less).

System 10 in FIG. 1 can be implemented as a compact system, making it useful as a portable instrument for analyzing a variety of analytes and samples in laboratory and clinical settings, and for home use. In some embodiments, a maximum overall dimension of system 10 is 10 cm or less (e.g., 8 cm or less, 6 cm or less, 5 cm or less).

In FIG. 1, illumination optics 105 include one or more spherical lenses that focus illumination light 115 to a spherical spatial region within sample 100. Similarly, measurement optics 106 and 107 include spherical lenses that collect measurement light 117 from sample 100. Accordingly, VOI 50 corresponds to a spherical spatial region within sample 100.

More generally, however, system 10 can include a variety of differently-shaped lenses in illumination optics 105 and/or measurement optics 106 and 107. For example, in some embodiments, illumination light 115 is focused by one or more cylindrical lenses in illumination optics 105, so that illumination light 115 effectively illuminates sample 100 along a line, rather than at a single point. That is, illumination light 115 is focused to a minimum beam waist along one of the two lateral dimensions (e.g., along either the x-coordinate direction or the y-coordinate direction), and not focused to a minimum beam waist along the other lateral direction. In certain embodiments, other types of lenses can be used, alone or in combination with the lens types disclosed above. These can include, for example, aspherical lenses, acylindrical lenses, and compound lenses consisting of a variety of different materials and surface shapes.

FIG. 2 is a schematic ray-tracing diagram showing a portion of system 10 that implements cylindrical focusing of illumination light 115. In FIG. 2, illumination light 206 from illumination source 204 is focused into sample 200 (which includes layers 201, 202, and 203) along a line or “sheet” by a cylindrical lens which forms illumination optics 205. The light rays of the sheet penetrate through layer 201 of sample 200 and are focused to a minimum beam waist in layer 202.

A spherical lens, which forms measurement optics 207, collects measurement light 208 emerging from a region of sample 200 illuminated by illumination light 206. However, because the lens in measurement optics 207 is spherical, the intersection of the sheet of rays defined by illumination optics 105, and a focal plane defined by measurement optics 207 corresponds approximately to an obloid (e.g., exaggerated ellipsoid) volume within sample 200. As discussed above, in some embodiments, this obloid volume corresponds to a VOI in the sample, or is positioned within a VOI of the sample. In other embodiments, the VOI is located outside the obloid region defined by the intersection.

Cylindrical focusing of illumination light can have a number of advantages in certain implementations. An exaggerated ellipsoid VOI is defined approximately by the waist diameter w₀ of the sheet of rays corresponding to illumination light 206 (i.e., the lateral resolution), and the depth of field (i.e., the axial resolution) of measurement optics 207. As such, the VOI can be diffraction-limited in size. The lateral and axial resolutions can be qualitatively defined according to the following equations:

$$\begin{matrix}Lateral Rsl \approx 2 {w}_{0} = \frac{2 λ}{π \cdot NA} & [ 1 ] \\ Axial Rsl \approx \frac{nλ}{{NA}^{2}} & [ 2 ]\end{matrix}$$

where λ is the wavelength of the light in air, n is the index of refraction, and NA is the numerical aperture of the illumination optics and the measurement optics, respectively.

When the VOI within the sample has a complex sub-structure (e.g., a highly non-uniform and/or scattering sub-structure), cylindrical illumination effectively “line-averages” over a spatial region of the sample—which can include a portion of the complex sub-structure. This averaging can reduce the susceptibility of the measured signal to the exact position of the VOI within the sample, making the measured signals more repeatable and reliable. Averaging typically yields a measurement signal corresponding to an average of a particular sample property at a specific depth along the z-coordinate direction within the sample.

Another advantage arises from the distribution of illumination light over an ellipsoid volume rather than focusing the light to a smaller region within the sample. By distributing the light over a larger volume within the sample, the potential for sample, e.g., animal or human tissue, damage due to the high intensity of the illumination light is reduced.

A further advantage arises when the measurement light is focused onto a slit-shaped aperture. By focusing illumination light 115 to an extended “line” within the sample and imaging the illuminated region of the sample onto a slit-shaped aperture 108, detection of the measurement light is simplified. In such a configuration, the optical element (e.g., measurement optic 107) that focuses measurement light 117 onto detector 109 can be a cylindrical lens.

As discussed above, the system—when configured as shown in FIG. 2—can be translated in each of three coordinate directions by translation stage 150, under the control of processor 111. Processor 111 can further be configured to determine the extent of variability in signals derived from measurement light by scanning the linear illumination “spot” produced by illumination optics 205 through a particular layer of the sample (i.e., in the x-y plane), such the top-most layer 200. By detecting signals corresponding to the measurement light at each location of the illumination “spot”, the extent of signal variability can be assessed. The spatial extent of signal variability can be used to infer, for example, the sensitivity of measured signals to improper positioning of the VOI within the sample, and/or to mechanical perturbations during measurements. Using this information, processor 111 can also position the VOI within a region of the sample that corresponds to suitably low susceptibility to signal variability.

When the illumination light sheet produced by illumination optics 205 in FIG. 2 is equally narrow, or approximately equally narrow, in width through multiple sample layers, measurement light can be detected from layers outside the layer that contains the VOI, and signals derived from the measurement light from these layers can be used to subtract background contributions to signals measured from the layer that contains the VOI. In this manner, the signal-to-noise ratio of measured signals obtained using the system shown in FIG. 2 can be significantly improved.

In some embodiments, additional control over the location of the VOI within the sample can be achieved by adjusting the sample relative to the positions of the various components of system 10. Because of the relatively complex nature and sensitive alignment among components of system 10, adjustment of the sample can provide a simpler method for controlling the location of the VOI.

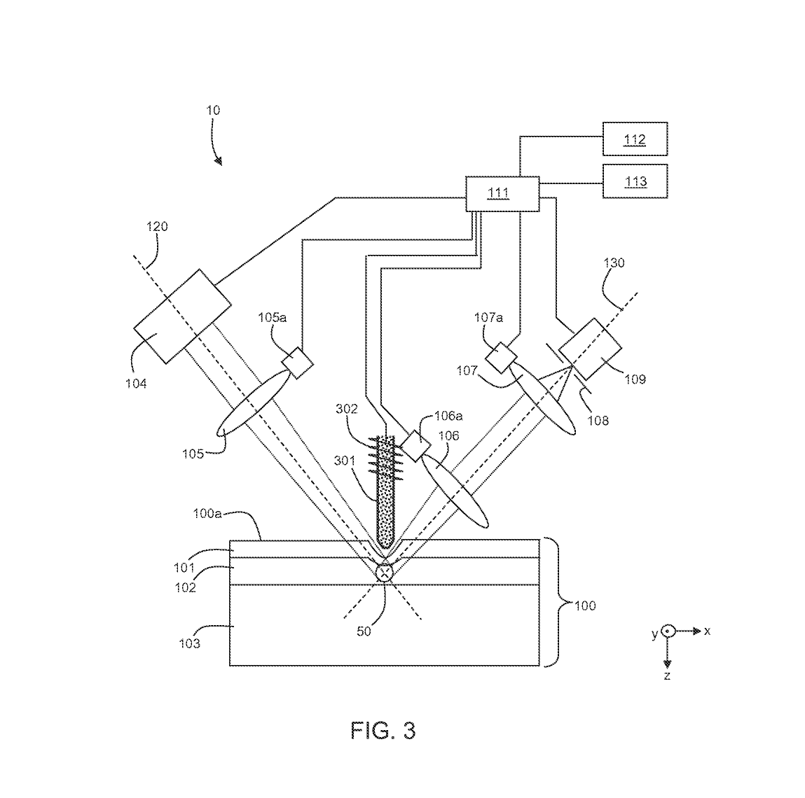

For samples that are deformable, system 10 can include a piston that exerts pressure on the sample to push a particular portion of the sample into a spatial region corresponding to the VOI defined by illumination optics 105 and measurement optics 106 and 107. FIG. 3 shows a schematic diagram of a system 10 that includes a sample manipulator 301 implemented as a piston. Manipulator 301 includes a mechanism 302 (e.g., a spring, a motor, or more generally, a translation mechanism) that allows manipulator to be moved in the z-coordinate direction. Manipulator 301 is coupled to processor 111, and receives control instructions from the processor.

During operation, manipulator 301 applies pressure to the sample (in either the +z or −z directions) to displace portions of the sample, thereby bringing a particular portion of the sample into the VOL. In this manner, the VOI can be positioned within any region of sample 100. In some embodiments, displacement of sample 100 via manipulator 301 can be combined with displacement of the various components of system 10 via translation stage 150 to selectively position the VOI within sample 100.

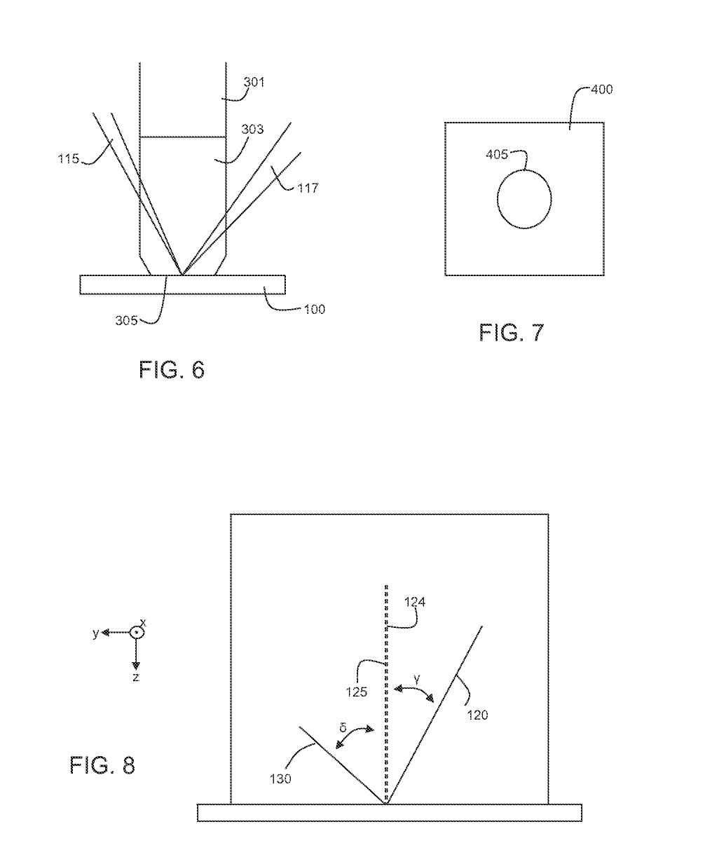

In some embodiments, manipulator 301 can have a transparent end member that contacts the sample, and further allows illumination light 115 to pass through it. FIG. 6 shows a schematic diagram of a sample manipulator 301 that includes a transparent end member 303. End member 303 includes a flat surface 305 that contacts sample 100 and applies pressure to the sample to deform it, as discussed above. Further, because end member 303 is transparent (or, more generally, non-opaque), illumination light 115 can pass through end member 303 and be incident on sample 100 (e.g., illumination light 115 can either be focused on the surface of sample 100, or to a region within the sample and below the surface). Similarly, measurement light 117 generated by the sample can pass through end member 303 before it is collected and measured.

Displacement of the sample using manipulator 301 as shown in FIG. 3 can have important advantages. For example, in certain embodiments, it can be easier and more reproducible to displace sample 100 in the +z or −z direction to position the VOI within a certain layer of the sample than to adjust translation stage 150, which is a mechanical system and therefore can be prone to mechanical perturbations and repeatability limitations. In contrast, for samples that are sufficiently flexible, sample 100 can be displaced in increments that can be much smaller and more repeatable than displacement increments achievable with a mechanical translation stage.

Other methods for displacement of sample 100 can also be used. For example, in some embodiments, vacuum displacement methods can be used. Magnetic positioning methods and/or hydraulic positioning methods are also suitable for displacement of sample 100.

Although in FIG. 3 sample 100 is displaced using manipulator 301, more generally any mechanism that translates sample 100 (or portions thereof) relative to the other components of system 10 can be used to selectively position the VOI within the sample. For example, in certain embodiments, sample 100 can be positioned on a translation stage coupled to processor 111, and sample 100 can be displaced relative to the components of system 10 by movement of the translation stage.

As a further alternative, in some embodiments, mechanisms that adjust the positions of illumination light 115 and/or measurement light 117 can be used. For example, beam-steering optical elements such as electronically-controlled mirrors can be used to actively position the illumination light (e.g., a light beam or sheet) to ensure that it couples effectively into the sample, and to direct the measurement light so that it is efficiently detected. The beam-steering optical elements can be connected to, and adjusted by, processor 111 for example, where measured signals from detector 109 are used to processor 111 to adjust the beam-steering optics to obtain measurements of sufficient quality.

In some embodiments, sample 100 can be displaced (e.g., using manipulator 301 or another device) periodically, such that a particular region of sample 100 enters the VOI with a prescribed periodicity. When measurement light is collected and detected during the periodic displacement of sample 100, the signal corresponding to the measured light will include contributions from the particular region of sample 100 that enters and leaves the VOI at the prescribed periodicity. Detector 109 and/or processor 111 can be configured to apply filtering or differencing techniques (such as lock-in amplification) to separate signal contributions from the particular region of sample 100 based on the periodicity of the signal contributions, thereby enhancing the selectivity with which signals from a desired region of interest in sample 100 are measured, and signals from other regions of sample 100 are excluded. For example, by applying these techniques, signal contributions from a very thin layer within sample 100 can be isolated, while signal contributions from other layers are filtered out.

In certain embodiments, sample 100 can include layers of significantly different index of refraction at the wavelength of illumination light 115 and/or measurement light 117. As a result, optical impedance mismatches at the interfaces of the materials can lead to angular deviations of the illumination and measurement optical paths as the illumination and measurement light passes through the interfaces between the materials. The process is analogous to the bending of light rays as the rays pass through an air-water interface.

Angular deviations of the illumination and measurement optical paths due to refractive index variations can affect the focusing and overlap of the optical paths within the sample, leading to enlargement of the VOI. To compensate for variations in index of refraction among various regions or layers of sample 100, system 10 can be configured to deform portions of sample 100 in regions where illumination light 115 passes through sample layer interfaces, and in regions where measurement light 117 passes through sample layer interfaces. Sample 100 is generally deformed in a manner such that the central axes 120 and 130 of the illumination optical path and the measurement optical path are incident on the interfaces at normal angles (or angles that are as nearly normal as possible), to reduce the effects of angular deviation of the illumination light and/or measurement light at the interfaces. In this way, by deforming sample 100, the size of the VOI within the sample can be kept small, and adjustment of the relative positions of many of the components of system 10 (e.g., source 104, illumination optics 105, measurement optics 106 and 107, and detector 109) can be avoided, which can greatly simplify the measurement of signals from samples featuring significant variations in internal structure.

Other advantages can also arise from deformation of the sample. For example, by deforming the sample, the concentration of certain analytes of interest within particular layers of the sample can be changed (e.g., either increased or decreased). Changing analyte concentrations in this manner can facilitate measurements of those analytes, or of other analytes.

Further, in certain embodiments, deforming the sample can reduce the amount of fluorescence generated in the more superficial sample layers from entering the measurement optical pathway, which would otherwise contribute background noise to the measured signals from the sample.

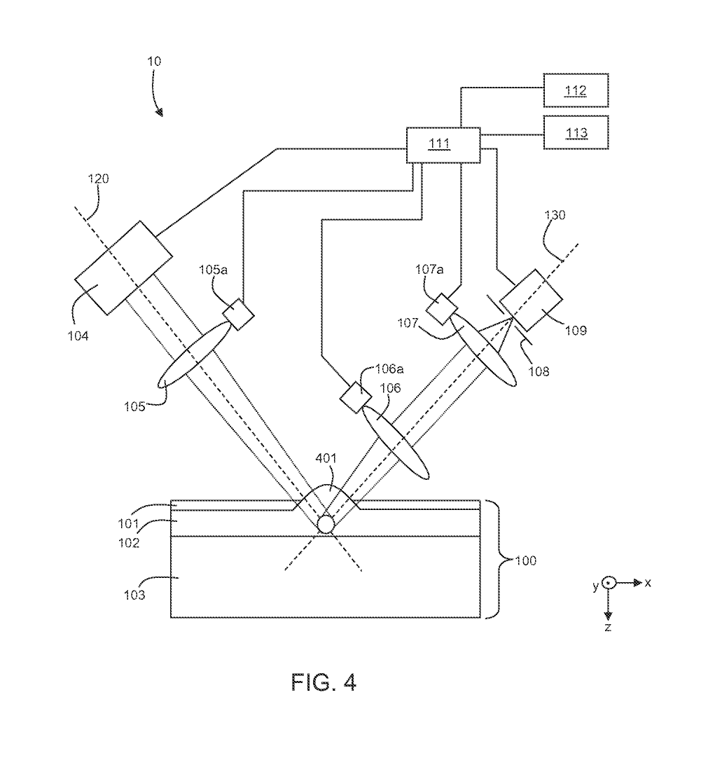

FIG. 4 is a schematic diagram of system 10 showing the deformation of sample 100. In FIG. 4, a portion 401 of sample 100 has been deformed by applying a force to the sample (e.g., along the −z direction). Portion 401 therefore forms a raised “bump” with a surface profile shaped so that central axes 120 and 130 are approximately normal (e.g., normal to within ±10°) to the surface of the bump where they intersect the sample. More generally, the surface profile of portion 401 is shaped so that central axes 120 and 130 are oriented closer towards normal incidence at the surface of the bump than they would otherwise be to the surface of an un-deformed sample.

In some embodiments, an index matching fluid or gel can be applied to the surface of sample 100 to further facilitate compensation of the refractive index mismatch at the sample surface. By using such a fluid or gel, a larger range of values for a and/or RI can be used, as refraction does not occur as strongly at the sample surface.

A variety of mechanisms can be used to deform sample 100 in the manner shown in FIG. 4. In some embodiments, for example, sample 100 can be deformed by a suitably positioned manipulator of the type shown in FIG. 3. The manipulator can include one piston, as in manipulator 301, or multiple pistons, fingers, or other elements to deform sample 100 to yield surface or interface profiles with more complex shapes. As discussed above, the mechanism used to deform sample 100 is connected to processor 111, and receives control instructions from the processor.

In some embodiments, the mechanism used to deform sample 100 is implemented as a plate with an aperture. FIG. 7 shows a schematic diagram of an embodiment of a plate 400 used for sample deformation that includes an aperture 405. During use plate 400 applies force to the surface of sample 100, and a portion of the sample protrudes upward through aperture 405 in response to the downward pressure applied by the plate. In certain embodiments, the plate can be displaced by a constant distance toward each sample so that the plate contacts the sample. As many tissue samples are comprised mostly of water, relatively consistent control over the displacement of the sample can be achieved by using a fixed displacement distance. Where the samples vary in composition by a significant amount, calibration settings derived from deformation experiments performed on the various types of samples can be retrieved and used to control the displacement of the plate mechanism. Further, in some embodiments, processor 111 can receive information from a user of the system, or from one or more sensors (e.g., pressure sensors), and the information (e.g., in the form of “stop” and “go” signals or pressure readings) can be used to apply a suitable amount of force to the surface of sample 100.

### Applications

The systems and methods disclosed herein are general, and can be used with a variety of different spectroscopic and imaging techniques. For example, the systems and methods can be used to illuminate the sample and measure Raman scattered radiation from the sample (i.e., angled confocal Raman spectroscopy). Although Raman scattering is a nonlinear optical process that typically produces relatively weak scattered light, Raman signals are highly useful for diagnostic purposes, as many analytes of interest within samples scatter light into characteristic Raman bands or frequencies that can be used to identify and quantify the analytes.

The systems and methods disclosed herein can also be used to measure fluorescence emission from samples (i.e., angled confocal fluorescence spectroscopy). Like Raman scattering, fluorescence emission typically occurs at particular frequencies or frequency bands, and can therefore be used to identify and quantify particular analytes within the sample. Samples can also be tagged with fluorescent entities that act as reporters, selectively binding to molecules or chemical structures within samples. Measurement and localization of fluorescence emission from within a sample can therefore provide information about the distribution of analytes or structures within the sample.

The systems and methods can also be used with other spectroscopic and imaging techniques, including (but not limited to) infrared absorption spectroscopy, second harmonic generation, third harmonic generation, and sum- or difference-frequency generation. More generally, the systems and methods disclosed herein can be used with all types of wave-guided energy, including acoustic spectroscopy, optical spectroscopy, radio-frequency spectroscopy, x-ray spectroscopy, and any other techniques that can be used for frequency-dependent spectral analysis.

A wide variety of different sample types can be investigated using the systems and methods disclosed herein. In some embodiments, the systems and methods can be used to make measurements on in vivo samples, including living humans and animals. In certain embodiments, the systems and methods can be used to measure signals from in vitro samples such as tissue sections, body fluids such as blood and urine, and individual cells on slides, in cuvettes, and mounted on various other types of substrates.

Samples can include one or more different layers, regions, and domains, and as discussed above, the VOI can be positioned within any one (or more) of the layers, regions, and domains, and at intersections between layers, regions, and domains. For example, the sample can be a tissue sample that includes layers corresponding to the epidermis, dermis, and one or more subcutaneous tissue layers. The VOI can be positioned within the subcutaneous tissue so that measurement light includes contributions primarily from analytes within blood vessels (e.g., blood components) in the subcutaneous tissue.

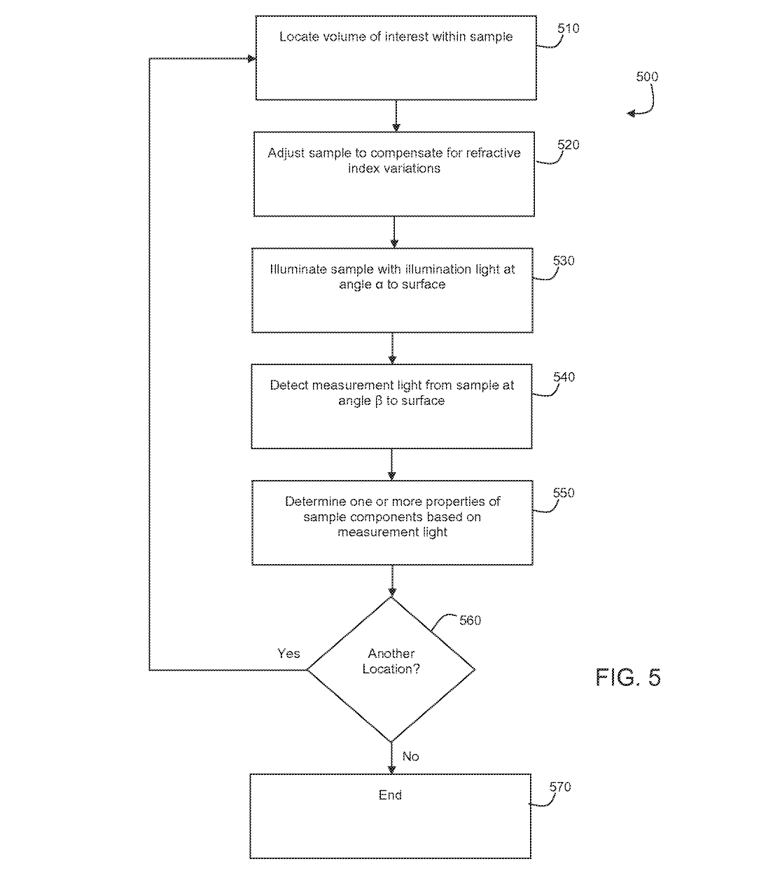

FIG. 5 is a flow chart 500 that shows a series of steps for measuring one or more properties of sample analytes using the systems and methods disclosed herein. Each of the steps shown in flow chart 500 can be performed in automated fashion by processor 111, by processor 111 using input from a system operator (e.g., via interface 113), or manually by the system operator.

In step 510, the VOI is positioned within the sample as discussed previously. In some embodiments, processor 111 can be configured to position the VOI after surveying multiple candidate sites within the sample, and selecting the site that corresponds to the smallest variation in measurement signal intensity, the largest measurement signal intensity, or another criterion. Processor 111 can also position the VOI using information from a system operator, such as depth-related information indicating that a particular layer of interest within a sample is located at a specific depth or within a range of depths.

In step 520, the sample is optionally adjusted to compensate for refractive index variations among different layers or domains within the sample. As discussed above, adjustment of the sample can include deforming the sample such that the central axes 120 and 130 of the illumination and measurement optical paths are approximately normal to the deformed sample surface.

Next, in step 530, the sample is illuminated with illumination light generated by source 104. Illumination occurs at an angle α with respect to a surface normal of the sample in the absence of deformation in step 520. Where the sample surface is locally deformed, illumination occurs at an angle α with respect to the surface normal of the sample in its un-deformed state.

In step 540, measurement light from the sample is collected by measurement optics 106 and 107, and detected by detector 109. Collection of the measurement light occurs at an angle β with respect to a surface normal of the sample in the absence of deformation in step 520. Where the sample surface is locally deformed, collection occurs at an angle β with respect to a surface normal of the sample in its un-deformed state.

Next, in step 550, processor 111 determines one or more properties of sample analytes—such as the presence or absence or specific analytes, the concentration or quantity of specific analytes, and/or the spatial distribution of specific analytes—from the detected measurement light. The one or more properties can be displayed as numerical values and/or as images of the sample, for example, using display 112, providing feedback to a system operator. The one or more properties can also be displayed on a variety of graphs or plots, and stored by processor 111 in a system storage unit for further use and analysis. The process by which processor 111 determines one or more properties of sample analytes will be discussed in greater detail below.

In some embodiments, information derived from the detected measurement light can be transmitted by processor 111 to a remote computing device, and some or all of the functions associated with determining the one or more properties of the sample analytes can be carried out by the remote computing device. The remote computing device can be, for example, a computer or workstation, a server, or more generally, any device or machine that includes electrical circuitry and/or software instructions for performing such calculations. Data can be sent over a variety of different networks and using various protocols, including WiFi networks, Bluetooth connections/networks, and cellular networks, for example.

Further, in certain embodiments, processor 111 can send information about the one or more sample properties to a remote computing device for display on the remote computing device's display unit. Suitable remote computing devices, networks, and protocols include those discussed above.

Next, in step 560, processor 111 determines (e.g., based on software or hardware instructions, or input from a system operator) whether to perform further analyses at other VOIs within the sample. If further locations are to be investigated, control returns to step 510, and processor 111 positions the VOI at a new location within the sample. By measuring signals at multiple locations within the sample, distributions of analyte properties can be determined. Further, spatially-dependent measurements can be used by processor 111 to construct images of the sample based on specific measured or determine values, such as images showing concentrations or amounts of specific analytes at multiple locations in the sample. If no further locations are to be investigated, the procedure ends at step 570.

As discussed above, Raman scattering is particularly useful for identifying and quantifying specific analytes in a sample, as many analytes of interest have particular Raman “fingerprints”—one or more Raman emission bands—that are characteristic of the analytes. The systems and methods disclosed herein can be used to identify and quantify many different sample analytes using Raman spectroscopy, including (but not limited to) glucose, hemoglobin, myoglobin, creatinine, lactate, ethanol, aldehydes, ketones, albumin, and nucleic acids such as DNA and various forms of RNA.

The various Raman spectroscopic methods disclosed in the references cited below for measuring specific analytes can be implemented by the systems disclosed herein to measure the analytes using angled confocal Raman spectroscopy. The entire contents of each of the references cited below are incorporated by reference herein.

Methods for identifying and quantifying glucose in samples are disclosed, for example, in PCT Patent Application Publication No. WO 2006/116637, and in PCT Patent Application Publication No. WO 2006/125430. Transcutaneous measurements for identifying and quantifying glucose and other analytes can be made at wavelengths in the near-infrared portion of the electromagnetic spectrum, as measurement light in this region of the spectrum is not as strongly absorbed as measurement light either in the visible region, or at longer wavelengths in the infrared region. As an example, signals at wavelengths such as (but not limited to) 830 nm, 785 nm, 808 nm, and 850 nm can be measured to identify and/or quantify glucose. Signals at shorter wavelengths can be used for samples in vitro (e.g., in glass cuvettes), as scattering and absorption do not occur as strongly for such samples as in tissue.

Methods for identifying and quantifying hemoglobin and myoglobin in samples are disclosed, for example, in PCT Patent Application Publication Nos. WO 2008/050291, WO 2004/109267. WO 2002/007585. WO 2008/052221, and WO 2013/096856, in U.S. Patent Application Publication Nos. US 2006/0074282 and US 2008/0117416, and in U.S. Pat. Nos. 7,544,502 and 7,113,814.

Methods for identifying and quantifying creatinine in samples are disclosed, for example, in PCT Patent Application Publication Nos. WO 2008/052222 and WO 2007/014173, and in U.S. Patent Application Publication Nos. US 2008/0117416 and US 2012/0309080. Methods for identifying and quantifying ethanol, aldehydes, and ketones in samples are disclosed, for example, in PCT Patent Application Publication No. WO 2002/060321, in U.S. Patent Application Publication Nos. US 2008/0081340 and US 2003/0208133, and in U.S. Pat. Nos. 8,515,506, 7,398,119, 8,781,757, and 6,610,351.

Methods for identifying and quantifying lactate in samples are disclosed, for example, in U.S. Patent Application Publication No. US 2006/0234386, and in U.S. Pat. Nos. 7,544,503, 8,452,365, and 8,467,053.

Methods for identifying and quantifying albumin in samples are disclosed, for example, in PCT Patent Application Publication Nos. WO 2013/096856 and WO 2009/149072, and in U.S. Pat. No. 7,627,357. Methods for identifying and quantifying nucleic acids in samples are disclosed, for example, in PCT Patent Application Publication Nos. WO 2012/162429, WO 2014/144883, WO 2006/066180, WO 2008/005899, and WO 1999/044045, in U.S. Patent Application Publication Nos. US 2005/014976 and US 2002/0150938, and in U.S. Pat. Nos. 6,972,173, 6,376,177, 5,306,403, and 7,985,539.

The methods and systems disclosed herein can also be used more generally for any measurements on samples, and in particular, for transcutaneous measurements on samples. Layered samples, such as layered tissue samples, are especially suited for the methods and systems disclosed herein, and the angled confocal geometry provides selective information on about each of the layers.

In general, the process by which electronic processor 111 determines properties of an analyte from a measurement signal derived from measurement light 117 is similar for many of the different spectroscopic techniques that can be implemented using the angled confocal spectroscopic systems and methods disclosed herein. When measurement light 117 is delivered to detector 109 by measurement optics 106 and 107, detector 109 detects the measurement light and generates a measurement signal (e.g., typically an electrical signal) that represents the measurement light. As an example, detector 109 can generate a spectrum of the measurement light that includes numerical values of the intensity of the measurement light as a function of wavelength.

Typically, the generated spectrum corresponds to a complex landscape in wavelength-space. The greater the number of analytes in the sample that contribute to measurement light 117 (e.g., by undergoing Raman scattering, fluorescence, or other optical processes in response to excitation by illumination light 115), the more complex the measured spectrum. An important aspect of spectroscopic techniques such as Raman spectroscopy and fluorescence emission spectroscopy is that specific analytes will typically generate signals (e.g., Raman scattered light or fluorescence emission) at particular wavelengths (or more generally, in particular wavelength bands) that are reproducible and characteristic of the analytes. Accordingly, these wavelengths and/or bands serve as spectral “fingerprints” for the analytes in the sample. Depending upon the range of wavelengths over which measurements are performed and the nature of the analytes, some analytes will generate signal contributions in only a single band or at a single wavelength, while other analytes will generate signal contributions at multiple wavelengths or in multiple bands.

Processor 111 can therefore use a priori information about characteristic wavelengths/bands for particular analytes to identify the analytes in the sample. That is processor 111 identifies the presence of a particular analyte in a sample by the presence of signals at one or more wavelengths (or in one or more bands) in the spectrum. While in principle many different chemical species can generate spectral signals at or near a particular wavelength, in practice information about the nature of the sample is used by processor 111 to identify analytes based on the various features of the spectrum. Processor 111 receives the information about the nature of the sample from a system operator, or by retrieving calibration information and settings from a storage unit.

As an example, for a blood sample, the sample will only contain a relatively limited number of possible analytes. A vast majority of chemical species will not be present in the sample. For each possible analyte in the sample, there will almost certainly be at least one wavelength or band which, if present in the measured spectrum, will serve as an unambiguous diagnostic indicator of the presence of the analyte in the sample. Similar considerations apply to most other samples as well. The systems disclosed herein can also include optical elements that isolate signals corresponding to particular analytes within the sample, e.g., filtering elements that isolate signals at wavelengths corresponding to the analytes.

To determine the amount or concentration of a particular analyte in the sample after the analyte has been identified, processor 11 can use calibration information. In general, the amount or concentration of the analyte is related to the intensities (e.g., “heights”) of the spectral features (e.g., “peaks”) that serve as indicators of the presence of the analyte in the sample. The amount or concentration of the analyte can be inferred based on the intensity of a single diagnostic peak, or based on the intensities of multiple diagnostic peaks for an analyte, where the multiple peak intensities are generally combined in an algorithm to produce a single-valued metric related to the analyte concentration or amount.

To convert diagnostic peak intensities into actual amounts or concentration values, calibration information is used by processor 111. To measure the calibration information, a number of phantom samples with varying known concentrations of an analyte of interest are measured, and the diagnostic peak intensities for each sample are determined and stored with the known analyte concentrations in an electronic record for the analyte. The accuracy of the calibration information can also be verified by determining the information via another measurement technique and comparing the two sets of calibration information.

When processor 111 identifies a particular analyte in a sample based on a peak in the measured spectrum, processor 111 also determines the peak intensity. The stored values of peak intensity as a function of analyte concentration for that analyte are then used by processor 111 to determine the actual amount or concentration of the analyte in the sample. Various methods of using the stored calibration information can be implemented by processor 111. In some embodiments, for example, processor 111 can determine the unknown amount or concentration of the analyte by interpolating between amounts or concentration values in the calibration information corresponding to peak intensities that bracket the measured peak intensity for the analyte. In certain embodiments, processor 111 can perform a regression analysis on the calibration information to generate a predictive equation that determines, for a given measured peak intensity, the corresponding analyte amount or concentration. In some embodiments, processor 111 can also perform post-processing of the measured spectra using chemometrics techniques to enhance the signal-to-noise ratio of the spectra.

Using calibration information as described above, processor 111 determines amounts or concentrations of some or all of the analytes identified in sample 100. When measuring calibration information, in can be important to ensure that the reference samples (e.g., phantoms) represent, as nearly as possible, the optical environment of real-world samples. Thus, for example, the analysis of different types of samples (e.g., blood, urine, skin, muscle tissue, etc.) will be based on independent calibration information for each different type of sample. Further, it is important to ensure when measuring calibration information that the measurement conditions (e.g., illumination light wavelengths, illumination focusing geometry, illumination and measurement angles, detector settings) are the same or similar to conditions when measurements on the sample are performed.

To determine the spatial distribution of one or more analytes in the sample, the above procedure for determining analyte amounts or concentrations is repeated at a number of different spatial locations in the sample by translating the VOI between measurements. Determining the distribution effectively yields a map of analyte concentrations or amounts in the sample as a function of position. As discussed above in connection with FIG. 5, in some embodiments, processor 111 can display one or more analyte “maps” to a user of the system.

In some embodiments, analytes within samples are not quantified in absolute terms, but are instead quantified in relative terms. That is, the measured property of the analyte —such as its concentration—is determined with respect to a reference, so that the numerical value of the property determined for the analyte is relative to the reference. For certain applications, relative values of properties are just as useful as absolute values. For example, in determining whether a concentration of a particular analyte in a sample is abnormally low or high, the measurement signal corresponding to the analyte can simply be compared to a reference signal (or a range of “normal” reference signal values) without ever determining the concentration in absolute units. In this way, abnormalities can be identified in the sample without ever relying on calibration information to convert measured signals to absolute numerical measurements.

In certain embodiments, the methods and systems disclosed herein can be used to identify conditions such as melanoma and breast cancer in tissue samples. The procedure for doing so is similar to the methods disclosed herein. However, as explained immediately above, these conditions can be diagnosed by comparing measurement signals to reference information (e.g., reference signals) to determine, in relative terms, a value of a property of the tissue sample (or a portion of the tissue sample). For example, for detecting these cancers, measured signals at one or more diagnostic wavelengths can be compared to calibration information such as reference signals at the same wavelengths from known healthy tissue. In some embodiments, the reference signals can be obtained on-the-fly from portions of the tissue sample that are known to be healthy. Alternatively, the reference signals can be measured from other samples at the same time, or pre-measured and stored.

If the measured signals at the diagnostic wavelength(s) are significantly higher (or lower) than the reference signals, at least a preliminary positive diagnosis can be made. As discussed above, measured analyte properties can be determined in relative terms for this purpose; conversion to absolute units of measurement is not required.

### Hardware and Software Implementation

Any of the method steps, features, and/or attributes disclosed herein can be executed by processor 111 and/or one or more additional electronic processors (such as computers or preprogrammed integrated circuits) executing programs based on standard programming techniques. Such programs are designed to execute on programmable computing apparatus or specifically designed integrated circuits, each optionally comprising a processor, a data storage system (including memory and/or storage elements), at least one input device, and at least one output device, such as a display or printer. The program code is applied to input data to perform functions and generate output information which is applied to one or more output devices. Each such computer program can be implemented in a high-level procedural or object-oriented programming language, or an assembly or machine language. Furthermore, the language can be a compiled or interpreted language. Each such computer program can be stored on a computer readable storage medium (e.g., optical storage medium such as CD-ROM or DVD, magnetic storage medium, and/or persistent solid state storage medium) that, when read by a computer, processor, or electronic circuit, can cause the computer, processor, or electronic circuit to perform the analysis and control functions described herein.

### Other Embodiments

A number of embodiments have been described. Nevertheless, it will be understood that various modifications may be made without departing from the spirit and scope of the disclosure. Accordingly, other embodiments are within the scope of the following claims.

1. A sample measurement system, comprising:
a light source and illumination optics arranged to direct illumination light onto a sample, wherein the illumination light propagates along an illumination optical path having an illumination central axis oriented at an angle α larger than 0° and smaller than 70°, relative to a normal to a surface of the sample located at a position where the illumination central axis intersects the sample surface;
measurement optics arranged to direct Raman scattered measurement light from the sample onto a detector, wherein the measurement light is collected along a measurement optical path having a measurement central axis oriented at an angle β larger than 0° and smaller than 70°, relative to a normal to the sample surface located at a position where the measurement central axis intersects the sample surface;
a detector arranged to receive the measurement light and to generate a measurement signal; and
an electronic processor configured to receive the measurement signal, and to analyze the measurement signal to identify at least one analyte in the sample.

2. The system of claim 1, wherein the electronic processor is configured to determine a concentration or amount of the at least one analyte in the sample.

3. The system of claim 1, wherein the measurement light is detected by the detector without passing through a spatial filtering aperture.

4. The system of claim 1, wherein the illumination optics comprise at least one cylindrical focusing element configured to focus the illumination light to an elliptical focal region within the sample.

5. The system of claim 4, wherein the cylindrically focused illumination light forms a light sheet within the sample.

6. The system of claim 1, wherein the illumination optics comprise at least one spherical focusing element configured to focus the illumination light to a spherical focal region within the sample.

7. The system of claim 1, wherein the illumination optics and the measurement optics define a spatial region corresponding to a volume of interest within the sample, and wherein the volume of interest is diffraction-limited in size in at least one dimension at the wavelength of the illumination light.

8. The system of claim 7, wherein the volume of interest is diffraction-limited in size in three dimensions at the wavelength of the illumination light.

9. The system of claim 1, further comprising a display unit, wherein the electronic processor is configured to display information about the identity of the at least one analyte on the display unit.

10. The system of claim 1, further comprising a sample manipulator coupled to the electronic processor, wherein the electronic processor controls the sample manipulator to deform the surface of the sample prior to illumination of the sample.

11. The system of claim 1, further comprising a sample manipulator configured to receive information from a user of the system and to deform the surface of the sample based on the information from the user.

12. The system of claim 10, wherein the electronic processor controls the sample manipulator to deform the surface of the sample so that an angle between the illumination central axis and the normal to the surface of the sample located at the position where the illumination central axis intersects the sample surface is smaller than an angle between the illumination central axis and the normal to the surface of the sample located at the same position when the surface of the sample is not deformed.

13. The system of claim 10, wherein the electronic processor is configured to deform the surface of the sample so that an angle between the measurement central axis and the normal to the sample surface located at the position wherein the measurement central axis intersects the sample surface is smaller than an angle between the measurement central axis and the normal to the sample surface located at the same position when the surface of the sample is not deformed.

14. The system of claim 1, further comprising a sample manipulator coupled to the electronic processor, wherein the illumination optics and the measurement optics define a spatial region corresponding to a volume of interest within the sample, and wherein the electronic processor is configured to control the sample manipulator to deform the sample using the sample manipulator to position a selected region of the sample within the volume of interest.

15. The system of claim 1, wherein the system is configured to analyze at least one analyte selected from the group consisting of glucose, lactate, creatinine, hemoglobin, an aldehyde, a ketone, and a cancer tissue marker.

16. The system of claim 1, wherein the system is configured to analyze a sample comprising multiple layers, and wherein the at least one analyte is localized in one of the layers.

17. The system of claim 1, wherein the light source and illumination optics are arranged to direct illumination light transcutaneously into an interior region of the sample.

18. A sample measurement method, comprising:
directing illumination light onto a sample along an illumination optical path for which an illumination central axis is oriented at an angle α larger than 0° and less than 70° relative to a normal to a sample surface located at a position where the illumination central axis intersects the sample surface;
measuring Raman scattered measurement light from the sample along a measurement optical path for which a measurement central axis is oriented at an angle β larger than 0° and less than 70° relative to a normal to the sample surface located at a position where the measurement central axis intersects the sample surface;
generating a measurement signal corresponding to the measurement light; and
analyzing the measurement signal to identify at least one analyte in the sample.

19. (canceled)

20. The method of claim 18, further comprising focusing the illumination light to an elliptical focal region within the sample.

21-23. (canceled)

24. The method of claim 18, further comprising deforming the sample to position a selected region of the sample within a volume of interest defined by illumination optics used to direct illumination light onto the sample and measurement optics used to measure Raman scattered measurement light from the sample.

25-27. (canceled)
